(19) United States
(12) Patent Application Publication
(10) Pub. No.: US 2018/0309708 A1
(43) Pub. Date: Oct. 25, 2018

(54) COMPUTER IMPLEMENTED SYSTEM AND METHOD FOR GENERATING REMINDERS FOR UN-ACTIONED EMAILS

(71) Applicant: JEFFERY DANIEL POTVIN, Ajax (CA)

(72) Inventor: JEFFERY DANIEL POTVIN, Ajax (CA)

(21) Appl. No.: 15/907,656

(22) Filed: Feb. 28, 2018

Related U.S. Application Data
(60) Provisional application No. 62/487,150, filed on Apr. 19, 2017.

(51) Int. Cl. H04L 12/58; G06F 17/30; G06N 99/00; G06N 5/04; G06N 3/00

(52) U.S. Cl. CPC H04L 51/22; G06F 17/30598; G06N 3/006; G06N 5/046; G06N 99/005

(57) ABSTRACT

The present disclosure envisages a computer implemented method and an automated, computer-implemented system that envisions selectively reminding a user about un-actioned emails, and especially important and urgent but un-actioned emails which are preferably related to work as well as the personal life of the user. Un-actioned emails typically include emails that are either un-read or un-answered or both. The reminders are generated in respect of the un-actioned emails, based on the urgency and importance determined to be associated therewith.

### CROSS-REFERENCE TO RELATED APPLICATION

The embodiments herein claim the priority of the U.S. Provisional Patent Application with Ser. No. 62/487,150 filed on Apr. 19, 2017, with the title, “SYSTEM AND METHOD OF URGENT COMMUNICATIONS ESCALATION”, and the contents of which is included entirely as reference herein.

### BACKGROUND

### Technical Field

The present disclosure relates to computer implemented systems and methods that track and process email communications. Particularly, the present disclosure relates to computer implemented systems and methods that automatically classify emails based on urgency factors and importance associated therewith. More particularly, the present disclosure relates to computer implemented systems and methods that create and direct timely reminders to an email recipient alerting him about a need to act upon/action an email deemed important/urgent.

### Description of the Related Art

Electronic mail, commonly referred to as ‘email’ is one of the most widely used inter-personal medium of communication. Email remains one of the most preferred mode of communication given the fact that it provides for the messages to he transferred to an intended recipient instantaneously, and in near real-time, in addition to being secure and robust. Email communications are transmitted either over the public Internet or over the intranet depending upon the nature of the communication, and warrants the senders and the corresponding recipients (and their respective computing devices) to be at least temporally connected to a pre-designated email server which works on a store-forward model by receiving an email from a sender and temporarily storing it until before deciphering the email address of the intended recipient, and subsequently transmitting the email to the intended recipient.

Email communications are widely used in the business community as well as in industrial environments to communicate and discuss matters related to business and work respectively. Similarly, email communications are in wide spread use within a multitude of family circles, for communicating and discussing matters related to personal life of individuals. One of the major advantages associated with email is the feasibility of email communication as a one-to-many communication medium which allows a sole email sender to send sole email to a plurality of intended recipients, thereby discussing a similar subject matter with multiple recipients in near real-time and without having to repeat himself.

Approximately ‘205’ Billion email messages are exchanged across the world every day, and individuals belonging to various walks of life including working professionals, home makers, businessmen and business women use emails to interact with their colleagues/peers/relatives. Typically, mails ex changed between working professions (including working professionals of varying ranks such as junior employees, senior executives, managers, vice-presidents, presidents and the like) entail an increased level of importance in comparison with emails exchanged between family members and acquaintances, given the fact that such communications involve dissuasions related to the work-life, and incorporate natters that typically at least partly dictate and influence the manner in which an organization—typically employing a multitude of individuals—functions and makes decisions having wide reaching consequences. Therefore, it is imperative that an individual who receives multiple work-related emails as well as personal emails on a regular basis, preferably prioritizes work-related emails over entail communications relating to other purposes including personal emails.

However, given the ease associated with sending emails, an email recipient might find it difficult to read and act upon a multitude of emails that he might receive during the course of the day. Moreover, the fact that each of those emails pertain to mutually different matters, and warrant actions entailing varying degrees of requirements and consequences further complicates the task of tracking each of the emails and initiating timely actions, without running through the risk of either missing out on at least some of the emails or delaying initiating responsive actions to at least some of the emails.

It remains a well-established fact that separating work-related emails from other forms of email communications and contiguously prioritizing work-related emails over other forms of email communications takes up a significant amount of time, and more importantly professional time of a working individual, and might in-turn negatively influence the time and the efforts that the individual dedicates to perform other professional responsibilities. Further, it has also been estimated that nearly 30% of all the emails received by an individual are opened. Given this estimate, it is fair to assume that there exists a decent likelihood that a working professional might fail to timely recognize and action upon a work-related email, given the volume of emails that he is likely to receive on a daily basis.

Further, in a typical work environment, employed professionals (employees are having to spend increasing amount of time and efforts into monitoring, managing and answering emails. Typically, an increase in the number of emails (official as well as personal) received by an employee also brings with it an inadvertent and unavoidable increase in the number of alerts/pop-ups/vibrations/pings that divert the attention of the employee (receiving the emails). As a direct consequence of being viable to receive an increased number of emails, an employee is forced to keep at least two email client applications active—one email client for work related emails and the other for personal emails—in addition to receiving email alerts, work related communications and personal communications (emails or other form of communication such as voice calls, SMS) on the mobile phone as well. While both work related email communications and personal communications form an important part of the social life of an employee, there is no denying that managing such email communications takes up a lot of time and effort on the part of the employee, all the while interrupting the employee's work schedule and causing the employee to be directly exposed to a large volume of incoming emails which in turn may cause the employee to miss out an important communication while over-emphasizing on managing/answering comparatively inconsequential communications.

Research into the number of emails received by employees and the time spent for managing and answering the received emails revels that an employee on an average invests ‘2 hours’ in a working day managing and answering emails (work-related and personal). When the number ‘2 hours’ is extrapolated to accommodate the total number of working hours spent managing and answering emails, it signifies a loss of productivity and a loss of man-hours which could have been, in hind-sight, used for productive purposes. Research also reveals that approximately ‘1’ out of every ‘3’ emails entail business value and ought to be treated as urgent and/or important. However, given the volume of incoming emails that an employee is expected to manage and action upon, there always exists a decent possibility that email(s) entailing business value are in a worst-case scenario not opened at all, and in a best-case scenario, are responded to/actioned upon after certain delay. Further, research also reveals that for an employee—whose work schedule is constantly interrupted by incoming emails—requires at least ‘15’ minutes of lead time to get back to his line of thought, after being interrupted once, and given the fact that an employee is likely to be interrupted several times during an working day by the incoming emails, it is always probable that a significant time period of the working day is lost while an employee recovers his work related focus and concentration after being interrupted. Further, such a loss of focus and concentration at work inadvertently results in critical/important email communications remaining unnoticed, responses to such critical important email communications being delayed, sales opportunities being lost, new client pitching opportunities being lost, delays in responding to important consumers, and delayed/missed work deadlines inter-alia.

Typically, majority of emails that are received by an employee during the course of his work schedule (work hours) are social media alerts/news alerts, promotional offers and the like. Given the fact that an employee is likely to receive hundreds of emails during the course of a working day, makes it difficult if not impossible for important/urgent email communications to be identified and separated for prioritized actioning. Further, at any given point of time, an employee has to shuffle between working on his laptop/desktop and answering his phone/tablet, and any incoming email communication (even though considered unwanted in hindsight) is likely to distract the employee and cause him to divert his attention away from his work-related responsibilities.

Typically, employees are expected to respond on only important/urgent work-related emails when they are off-duty and not engaged in their work. However, absence of a framework to separate important/urgent work-related emails from other non-critical work-related emails results in off-duty employees being distracted by non-critical work-related emails, which would not have warranted immediate attention and/or action, thereby interfering with and negatively impacting the personal and social life of the employee.

Mindful of the aforementioned scenario, prior arts systems and methods proposed enabling email recipients to manually identify and flag emails as important, so that the email client (software program providing email access and related services) reminds the email recipients about flagged emails at subsequent time intervals. Further, prior art systems and methods also proposed enabling email recipients to manually categorize certain emails as important and store them in separate web folders. However, one of the major drawbacks associated with the aforementioned prior art systems and methods was that they did not encompass the ability to automatically determine the urgency and importance of an incoming email, and accordingly alert (and when necessary remind) the email recipient about the need to act upon an (the) urgent and important email.

Therefore, in view the drawbacks associated with the prior art systems and methods, there has been felt a need for an automated system (and method) that (automatically) determines the level of urgency and importance associated with each of the incoming emails, and subsequently informs and whenever necessary reminds the email recipient about the presence of urgent and important emails in his mailbox warranting timely action. Further, there was also felt a need for an automated system and method that obviates the need on the part of the email recipient to continuously monitor his mailbox for important and urgent emails, and also to manually differentiate and segregate urgent/important emails from other emails communications not warranting immediate attention. Further, there has also been felt a need for an automated system and method that reminds the email recipient about the presence of urgent/important emails warranting his attention, thereby functioning as an effective, computerized, virtual office assistant that ensures that the email recipient is always informed and subsequently reminded about urgent/important emails.

There was also felt a need for systems and methods that ensure that only critical, urgent/important email communications are brought to the notice of an employee on a priority basis, thereby enabling the employee to concentrate on his work while also answering email communications deemed urgent and/or important. Further, there was also felt a need for systems and methods that effectively segregate the emails primarily as personal emails and work-related emails, before further categorizing them and selectively highlighting them based on whether they are determined—using a computer implemented algorithm—to be urgent and/or important, thereby allowing the email recipient to concentrate only on the highlighted emails. Further, systems and methods that selectively highlighted the incoming emails depending upon whether an employee was at work or away from work were also highly desirable. Further, there was also felt a need for systems and methods that ensured that an employee dedicated a major part of his work schedule to fulfilling his primary work-related responsibilities and never neglects an email communication that warranted immediate response/action.

### OBJECTS

An object of the present disclosure is to envisage a system, and method that tracks the incoming emails of a user, and determines the urgency and importance associated therewith.

Yet another object of the present disclosure is to envisage a system and method that implements a combination of predetermined analytical processes to analyse incoming emails.

Still a further object of the present disclosure is to envisage a system and method that determines the nature of and the importance associated with each of the incoming emails and categorizes the emails based on their importance and type.

One more object of the present disclosure is to envisage a system and method that analyses the emails in real-time, in addition to providing for a historical analysis of email-based communications.

Another object of the present disclosure is to categorize the emails based at least on the identity of the email sender, and further based on a semantic, temporal, and pragmatic analysis of the contents of the email.

Still a further object of the present disclosure is to envisage a system and method that escalates any un-actioned mails to higher ranked officials (relative to the organizational rank of the intended recipient) only after analysing the un-actioned emails and confirming that the intended recipient has not responded to/acted upon said emails.

One more object of the present disclosure is to envisage a system and method that identifies any breaches in email-based user-to-user communication protocols, by continuously monitoring and analysing all the emails (incoming and out-going) routed through specific mail server(s).

Another object of the present disclosure is to envisage a system and method that incorporates the ability and the rules to facilitate automatic identification of events/actions/sequences/situations discussed via email communication, and subsequently forecast the future course of action based thereupon.

Yet another object of the present disclosure is to envisage a system and method that has been programmed to track the efficiency of employees at least in part based on the respective email communications and determine respective employee behaviour based on the corresponding email communications.

Still a further object of the present disclosure is to envisage a system and method that determines employees' organization behaviour in addition to employee efficiency as well as organizational efficiency, based on the corresponding email communications.

One more object of the present disclosure is to envisage a system and method that tracks every email communication emanating from predetermined mail servers, and subsequently analyses the contents of each of said email communications, in addition to monitoring the user-actions performed on each of said email communications.

### SUMMARY

The present disclosure envisages a computer implemented method and an (automated) system that envisions selectively reminding a (first) user about un-actioned emails, and especially important and urgent but un-actioned emails (un-actioned emails preferably related to work as well as personal life of the first user). Un-actioned emails in the context of the present disclosure are considered as referring to emails that are either un-read or un-answered or both. The reminders are generated in respect of the un-actioned emails, based on the urgency and importance determined to be associated therewith.

In accordance with the present disclosure, a computer processor accesses the mailbox of the user, and analyses each of the emails in the mailbox to segregate answered emails and un-answered/un-read emails. Subsequent to identifying the un-actioned emails, and segregating answered emails from un-actioned emails, the processor analyses the header, the subject-line and the body of each of the unanswered emails, to identify key phrases that indicate/signify an emotion intended to be conveyed by each of the said un-actioned emails. Preferably, predetermined sentiment analysis rules are implemented by the processor to determine.

Subsequently, based on the analysis of the header, subject-line and body of each of the un-actioned emails, the processor also determines whether the un-actioned emails relate to and/or describe a specific event or a timeline or an action, which are required to be addressed on an immediate basis by the user. Preferably, predetermined semantic analysis rules are implemented by the processor to analyse the header, subject-line and body of the un-actioned emails, and determine whether the un-actioned emails describe a specific event or timeline or an action.

Subsequently, based on the said predetermined semantic analysis rules, the processor also determines whether (each of) the un-actioned emails specify any matters/issues having an urgency factor therewith (an ‘impending deadline’ is an example of an urgency factor). The processor also determines, using the semantic analysis rules, any time-sensitivity associated with the urgency factor specified in each of the un-actioned emails.

Further, the processor also analyses email-trails corresponding to each of the un-actioned emails and represents an un-actioned email and a corresponding email-trail on a temporal space, in addition to determining the temporal progression of the email-trail incorporating the said unanswered email. Preferably, the processor models the user's behavioural profile at least partly based on the temporal progression of the email-trail which provides an insight into the manner in which the user typically handles emails addressing a specific subject matter and originating from the same sender. Further, the processor also undertakes a pragmatic analysis of at least the subject-line and the body of each of the un-actioned emails and analyses the intentions conveyed by each of the un-actioned emails.

The processor determines the urgency and importance associated with each of the un-actioned emails by taking into consideration the key-phrases extracted from (the subject-line and the body) of un-actioned emails, the time-stamps, events and actions specified in the (subject -line and the body) of un-actioned emails, the header of the un-actioned emails—which describes the identity (name) of the email sender—using which the designation of the email sender is determined, urgency factors determined to be associated with the un-actioned emails, temporal dimension of each of the un-actioned emails, temporal progression associated with the email-trails incorporating each of the un-actioned emails, and the intentions conveyed by the subject-line and the body of the un-actioned emails. In the event that an un-actioned email is determined to be important and urgent, based on the aforementioned factors, then the processor generates a reminder which is directed to the user, and which alerts the user about the urgency and importance associated with a particular un-actioned email, and preferably triggers him to read through and act upon the said email.

In accordance with the present disclosure, the reminder generated by the processor in respect of an un-actioned email is directed to the first user, via a communication medium other than an email-based communication medium. Preferably, the reminder is transmitted to the user as an SMS or as an automated telephone call. Further, the reminder is also transmitted to a second user, who is preferably superior to the first user in terms of an organizational rank—in the event that the reminder corresponds to a work-related email—so as to alert the said second user about un-actioned work-related email(s) on the mailbox of the first user. Further, in the event that the reminder corresponds to a personal email, then the reminder is redirected to a member of the family of the first user (member of the family identified based on a predetermined relationship graph corresponding to the first user), so as to alert the said family member about a personal email left un-actioned by the first user.

In accordance with another aspect of the present disclosure, the first user is selectively prompted to define a set of keywords that he deems important and essential. Secondly, the (first) user is also prompted to specify email IDs that according to him should be given a priority when processing the incoming emails. Further, the user is selectively prompted to rank each of the said keywords in an increasing order of importance so that any incoming emails incorporating the said keywords (provided by the user) are automatically regarded as urgent and important. Further, in the event that the user-defined keywords and the user specified email IDs are determined not to provide a sufficient basis for categorizing any of the incoming emails as important and urgent—absence of user defined keywords and user specified email IDs in a particular email would curtail the abilities of the system in deciding the urgency and importance associated with the (particular) email—then the system (envisaged by the present disclosure) performs a plurality of predetermined analytical procedures (for instance, semantic analysis, sentiment analysis, temporal analysis and pragmatic analysis) on the incoming emails and basis the said analytical procedures, categorizes the incoming emails as important and urgent.

### BRIEF DESCRIPTION OF THE DRAWINGS

The other objects, features and advantages will be apparent to those skilled in the art from the following description and the accompanying drawings in which:

FIG. 1 is a flow chart illustrating the steps involved in the computer implemented method for generating reminders corresponding to emails regarded as urgent and/or important; and

FIG. 2 is a flow chart illustrating the steps involved in an alternate embodiment corresponding to the method for generating reminders for emails regarded as urgent and/or important.

### DETAILED DESCRIPTION

in order to effectively address the drawbacks discussed hitherto, the present disclosure envisages a computer-implemented (automated) method and a system, and a computer program product that track a mailbox of a user (preferably a working professional), and automatically analyze each of the (incoming, preferably un-actioned) emails and determine at least the importance and urgency (factors) associated with each of the emails and selectively categorize the emails as being urgent and/or important based on the importance and urgency (factors) determined to be associated therewith. Further, reminders in respect of emails determined to be urgent and/or important are generated and subsequently directed to the user informing him and alerting him about the need to answer/act upon such (un-actioned) emails in a timely manner.

The computer implemented system, the method and the computer program product envisaged by the present disclosure, and the technical features and functionalities thereof are explained taking into consideration an exemplary first user (also referred to as ‘email recipient’) employed with a particular organization and designated to receive work related emails on a mailbox linked to his corporate email ID. Preferably, the emails directed to the mailbox of the first user originate from people (email senders) who interact with the first user in their official capacity in order to discharge their professional duties and responsibilities, and also to either request or instruct—based on their respective requirements and designations—the first user to discharge his profession duties and responsibilities at least based on the matter(s) described/elaborated in the said emails. Alternatively, or preferably additionally, the mailbox of the first user is also designated receive personal emails from people who form a part of the family network corresponding to the first user. The present disclosure and the features and functionalities thereof are explained in further detail in the below mentioned paragraphs with an emphasis on analysis and categorization of work related emails of the first user, and those skilled in the art would readily recognize that the features and functionalities described with reference to work related emails could also be extended to personal email, and that the explanation provided in the below mentioned paragraphs should not be considered in a limiting sense.

The present disclosure envisages storing and maintaining all the information relevant to the first user in a repository. The repository preferably stores the personal information corresponding to the first user including name, employee ID, designation, contact details of the first user (including corporate email ID, personal email ID, direct line number, mobile phone number), date and place of birth, and employment details. Further, the repository is also configured to store any employment information relevant and applicable to the first user including first user's position in corporate hierarchy (organizational hierarchy), information identifying personnel reporting to the user, information identifying a second user whom the first user reports to and the like. Further, the repository is also configured tri store information identifying the family circles of the first user, including the relationship information useful in identifying family members of the first user and differentiating colleagues, superiors and subordinates of the first user from the family members of the first user.

The execution of the computer implemented method is begun with the launch/execution of the computer program product on a computer system which is preferably used for accessing the mail box linked to (preferably) the corporate email ID of the first user. Subsequent to the launch of the computer program product, the emails received by the first user's mailbox are analysed in seriatim. Post the analyses, preferably the emails which have not been read and the emails that have not been replied to are identified. The term ‘un-actioned email’ as used in the present disclosure refers to emails that have not been read as well as the email that have not been replied to.

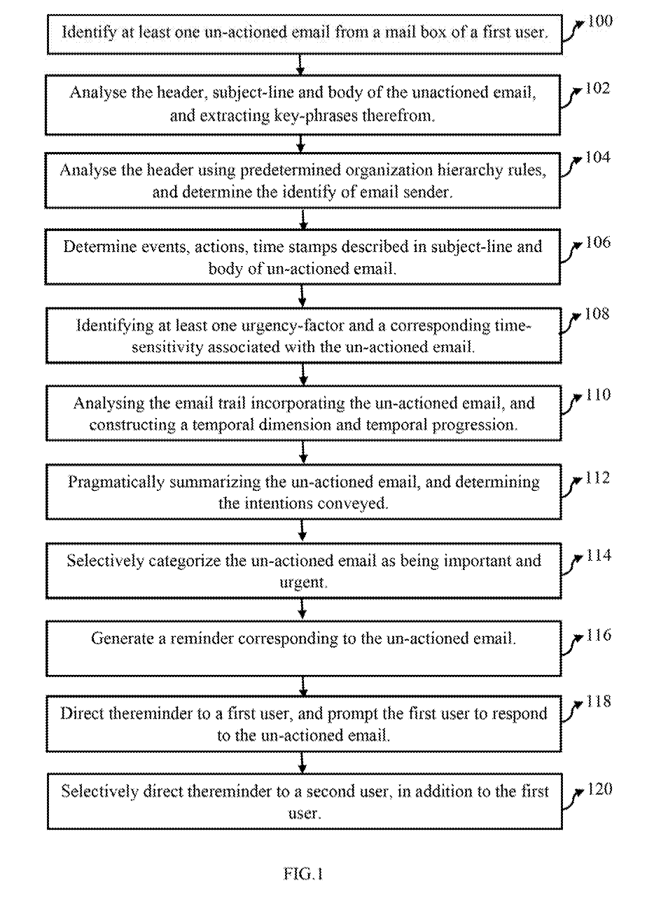

FIG. 1 of the present disclosure describes the steps involved in the computer implemented method for generating reminders about un-actioned emails regarded as being urgent and/or important. The implementation of the said computer implemented method begins with the launch of the said computer program product and proceeds to step 100 at which a computer processor (not shown in figures)—which forms a part of the computer implemented system envisaged by the present disclosure—analyses the mailbox of the first user and identifies the un-actioned emails—emails that have either remained unread or have not been replied to. Hereafter, the remaining steps of the flowchart described in FIG. 1 are explained using a solitary un-actioned email for the sake of convenience, and it would be evident to those skilled in the art that the same phenomenon, as explained herein below could be extended to analyse/process a plurality of un-actioned emails.

At step 102, a specific un-actioned email is analysed by the processor. Preferably, the processor analyses the header, the subject-line and the body of the un-actioned email. Predetermined sentiment analysis rules preferably stored on a repository and accessible to the processor are utilized to analyse the header, subject-line and the body of the un-actioned email, and to extract from the header, subject-line and the body, the words that convey a specific sentiment—including a positive sentiment, negative sentiment and a neutral sentiment. For instance, words such as ‘bad’, ‘terrible’, ‘never’, ‘no’, ‘delay’ are determined to be conveying a negative sentiment, while words such as ‘good’, ‘convinced’, ‘happy’, ‘glad’, ‘superb’, ‘great’ are determined to be conveying a positive sentiment. Further, terms such as ‘agreed’, ‘acknowledged’ could signify a neutral sentiment. In accordance with the present disclosure, the words extracted from the header, subject-line and the body, and identified to be associated with one of the sentiments (viz, positive sentiment, negative sentiment and neutral sentiment) are termed as ‘key-phrases’ which are subsequently used as pointers by the processor to selectively categorize the un-actioned email as urgent/important.

Further, at step 104, the processor specifically re-processes the header of un-actioned email to determines the email ID of the email sender, and thereafter deciphers the identity of the email sender based on the determined email ID. Preferably, the identity of the email sender thus determined specifies the professional identity of the email sender which includes information pertinent to the organization that the email sender works for and his corresponding designation within the said organization. Thereafter, the processor accesses predefined organizational hierarchy rules—preferably stored in the repository communicably coupled to the processor—and identifies the designation of the email sender. One of the possible scenarios in this case is that the email sender is employed with the same organization as that of the first user/email recipient. Another possible scenario involves the email sender being employed with a different organization but maintaining a work-related interaction with the first user/email recipient. In both of the aforementioned scenarios, the processor determines the designation of the email sender based on the user identity which is in turn deciphered from the email header and uses the ‘designation’ of the email sender as a pointer for selectively categorizing the un-actioned email as urgent and/or important.

Further, at step 106, the processor re-analyses the subject-line and the body of the un-actioned email to identify any characters/words that describe any actions/events. For instance, the words such as ‘meeting’, ‘lunch’, ‘dinner’, ‘venue’, ‘conference’, ‘movie’, ‘flight’, ‘arrival’, ‘departure’ indicate time bound (time sensitive) actions or events relevant to the first user/intended recipient and might indicate a time bound action to be performed by the first user/intended recipient. For instance, if are un-actioned email received by the first user's mailbox at 9:00 AM relates to a meeting scheduled at 12:00 PM same day, the first user/intended recipient preferably needs to confirm his availability for the meeting at least an hour prior to the scheduled. meeting time. It is reasonable that an email discussing a meeting schedule would include a subject-line and/or header which preferably includes the words ‘meeting’, ‘today’, and ‘12:00 PM’. The processor accordingly applies a predetermined set of semantic analysis rules to the un-actioned email and based on said semantic analysis rules identities the words ‘meeting’, ‘today’ and ‘12:00 PM’ as the keywords that convey an action/event needed to be addressed on the part of the first user/intended recipient.

Further, based on the said semantic analysis rules, the processor also identifies the keyword ‘12:00 PM’ to be specifying the scheduled time of the meeting. In another exemplary scenario, presence of words (action verbs) such as ‘expedite’, ‘respond’, ‘remind’, ‘process’, ‘follow-up’, ‘send’, ‘receive’, ‘as soon as possible’, ‘immediately’ in either the subject-line or the body (or both) of the un-actioned email point to (suggest) an action to be performed by the first user/intended recipient, and the time-related constraints (if any) associated with the actions. For example, analysis of exemplary statements (present in the un-actioned email) such as ‘respond on an immediate basis’, ‘proceed to the arrival terminal as soon as possible’, ‘reach the meeting room at 10:00 AM’, enables forecasting the actions to be taken by the first user, and the time frame (and time sensitivity) associated with execution of the actions. The processor envisaged by the present disclosure semantically analyses the un-actioned email to firstly extract such keywords that may indicate an action due on the part of the user, or an event or a task due to performed by the first user/intended recipient in a time bound manner, and secondly analyse the extracted words to decipher the time bound action(s) to be undertaken by the first user/intended recipient, and thirdly use the keywords identified based on the semantic analysis of the un-actioned email, as pointers to selectively categorize the un-actioned email as urgent/important.

Further, at step 108, the processor further analyses the un-actioned email (preferably the subject-line and the body) using the predetermined semantic rules to determine the presence of any words indicative of an urgency factor associated with the actions described in the un-actioned email. At step 106 the processor identifies the words that are indicative of an action to be undertaken by the user in response to the un-actioned email. Subsequently, at step 108 the processor determines the urgency-factors associated with the identified actions. For instance, the presence of words such as ‘immediate’, ‘as soon as possible’, ‘right now’, ‘right-away’, and the presence of time-stamps succeeded or preceded with words (for example, meeting today at 10:00 AM, reach the airport before 5:00 PM) are determined to be conveying/suggesting an urgency factor which in-turn warrants the action to be performed by the user within a pre-set deadline or on an immediate basis. The actions and the corresponding urgency factors determined this way are used as pointers to selectively categorize the un-actioned email as urgent/important.

At step 110, the processor a temporal analysis of the un-actioned email and the email trail incorporating the un-actioned email, and generates a ‘temporal graph (preferably a line graph)’ that represents each of the emails (preferably both actioned emails and un-actioned emails), and the actions/activities performed by the user on each of the emails (for example, in the context of temporal analysis, reading an email and replying to an email are considered as actions/activities) on a time based scale, preferably with ‘time’ being denoted on X-axis of the temporal graph and the actions/activities (reading, replying, and the like) performed on the email being represented on a Y-axis. In accordance with the present disclosure, generating a temporal graph representative of an email trail includes determining parameters including but not restricted to ‘span’, ‘frequency’. ‘lag’, ‘count’, ‘interval’ and ‘time of the day’, and representing each of the said parameters on the time-based scale, with ‘time’ being represented on the X-axis and the parameters (signifying the activities/actions performed by the first user on the email trail) being represented on the Y-axis.

In accordance with the present disclosure, the (time) span corresponding to the email trail incorporating the unanswered email is determined based on the total time elapsed between receiving the first email of the email trail and receiving the last email on the email trail. Further, the ‘frequency’ corresponding to the email trail is determined based on the total number of emails exchanged via the said email thread over a predetermined time period. Further, the ‘lag’ associated with the email trail represents the time elapsed since the last communication on the email trail. Further, the ‘count’ corresponding to the email trail represents the total number of emails present in the email trail. Further, the term ‘interval’ describes the time elapsed between closing an existing thread and opening a new thread involving common sender and recipient(s). Lastly, the parameter ‘time of the day’ describes the time at which each of the emails in the email trail were received by the first user.

In accordance with the present disclosure, each of the parameters i.e., the ‘span’, ‘frequency’, lag', ‘count’, ‘interval’ and ‘time of the day’ corresponding to the email trail are analysed and represented in the form of respective temporal graphs. Subsequently, the processor determines a temporal progression (over time) corresponding to the email trail incorporating the un-actioned email. In accordance with the present disclosure, the temporal progression of an email trail incorporating the un-actioned email denotes the activities performed by the user on each of the emails (of the email trail incorporating the un-actioned email) over a predetermined period of time.

In accordance with the present disclosure, temporal analysis of each of the un-actioned emails and the corresponding email trail and the parameters ‘span’, ‘frequency’, ‘lag’, ‘count’, ‘interval’ and ‘time of the day’, provides insights into how the emails directed to the first user have actually been handled. Additionally, temporal analysis also makes it possible for an activity density relationship to be derived for each of the mail trails, in addition to enabling identification of most active email trails as well as email trails which have seen comparatively lower levels of user activity. Additionally, the temporal analysis also enables identification of the total time a particular email trail has been active, time elapsed since an email trail was last active, typical lead time taken by the first user to read an email, typical lead time taken by the first user to respond to an email, the time difference between the oldest email in the email trail and the most recent email, and the like. Basis the aforementioned insights and the parameters that denote the aforementioned insights, weights could be assigned to each of the parameters while determining the activity density of each of the email trails and while determining a temporal progression of each of the email trails. Subsequently, based on the temporal progression associated with the email trail incorporating the unanswered email, the processor determines whether to categorize the unanswered email as important/urgent. Further, the parameters ‘span’, ‘frequency’, ‘lag’, ‘count’, ‘interval’ and ‘time of the day’, and the weights, assigned to each of the said parameters are used at least in-pan to calculate a pragmatic analysis score.

In accordance with the present disclosure, execution of pragmatic analysis procedure—as specified in step 112—and the calculation of a pragmatic analysis score is influenced by deciphering of the context of the unanswered email by the way of performing sentiment analysis and semantic analysis (described in steps 102-108) of the unanswered email. As described earlier in steps 102-108, sentiment analysis and semantic analysis of the unanswered email results in the identification of key-phrases that might inter-alia deduce the sentiment associated with the unanswered email, identify an event/action described in the unanswered email, and deduce any time-sensitivity and urgency factors associated with the unanswered email. Further, analysis of the profile of the email sender (with the sender being identified by the way of analysis of email header), including analysis of the sender's corporate designation or the sender's relationship with the first user (relationship is determined only in the event that the analysis of email header identifies the sender to be not a colleague, but either a friend or an acquaintance or a family member) helps forecast the context of the (unanswered) email.

In accordance with the present disclosure, the sentiment inferred to be associated with the unanswered email, the context of the email derived based on the semantic analysis, the urgency factors and time sensitivity deduced to he associated with the unanswered email, the information corresponding to the identity/profile of the email sender—which in turn enables at least part forecast of the context of the email when the sender's identity/profile information is combined with the sentiment, context, urgency factors and time sensitivity deduced to be associated with the unanswered email—and the temporal analysis of the email trail incorporating the unanswered email using the parameters ‘span’, ‘frequency’, ‘lag’, ‘count’, ‘interval’ and ‘time of the day’, are preferably combined and pragmatically analysed using a predetermined pragmatic analysis model—for example, regular expression based pragmatic model or a formal language based pragmatic model, supervised learning based pragmatic model—to determine at least the context and tonalities associated with the unanswered email and the intentions conveyed via the said context and tonalities, in addition to pragmatically forecasting the possible responses to the unanswered email having the said (determined) context and tonalities.

Preferably, the pragmatic analysis indicates the overall tone, context, and the probable meaning (intentions) associated with the deduced tone and the context of the unanswered email. Preferably, pragmatic analysis of the unanswered email deduces the overall intention of the unanswered email (based at least on the context and tonalities associated with the unanswered email, and further based on the sentiment analysis, semantic analysis of the unanswered email, and the analysis of email sender profile), and also infers the manner in which the unanswered email having a particular tone and context should be replied to. Preferably, the pragmatic analysis score is calculated post determining the context and tonalities associated with the unanswered email and calculating a relative distance between the context and tonalities of the unanswered email and the possible responses to the unanswered email, which are deduced/inferred by the pragmatic analysis model.

In accordance with the present disclosure, the un-actioned email when subjected to sentiment analysis, provides for extraction of a set of key-phrases therefrom, which when analysed forecast a sentiment associated with the unanswered email. Further, when the unanswered email is subjected to semantic analysis, a set of key-phrases, which identify at least an event or an action to be performed by the first user are deduced. Further, semantic analysis of the unanswered email also provides for determining again based on the key-phrases, any time-sensitivity and urgency factors described in the email. Further, temporal analysis of the email trail incorporating the un-actioned email results provides for a variety of temporal parameters relevant to the email trail which include but are not restricted to ‘span’, ‘frequency’, ‘lag’, ‘count’, ‘interval’ and ‘time of the day’ are determined. Subsequently, a temporal progression corresponding to the un-actioned email with reference to the email trail (incorporating the un-actioned email) is determined. Further, the un-actioned email is also pragmatically analysed using a predetermined pragmatic analysis model to identify the tonalities and the context associated with the un-actioned email, and to pragmatically forecast possible replies to the un-actioned email incorporating the said context and tonalities. Further, at step 116, the processor categorizes the un-actioned email as either important or urgent or both, based on the sentiment analysis, semantic analysis, pragmatic analysis of the un-actioned email. The processor, while designating the un-actioned email as important/urgent also considers the results of the temporal analysis of the email trail incorporating the un-actioned email, and the email sender's identity (relative to the position of the first user in an organizational hierarchy or relative to the positioning of the email sender within the family circles of the first user) which is in tam deciphered from the analysis of corresponding sender email ID.

Further, at step 116, basis the sentiment analysis, semantic analysis, pragmatic analysis of the un-actioned email, and the temporal analysis of the email trail incorporating the un-actioned email, and the email sender's identity, the processor selectively categorizes the unanswered email as being either urgent or important or as both urgent as well as important. Subsequently, for an un-actioned email that has been determined to be either urgent or important or both, the processor generates a reminder which is typically directed to the first user reminding him about an urgent and/or important email remaining un-actioned/unanswered in his mailbox linked to his corporate email ID. Preferably, the reminder in respect of the urgent and/or important email is directed to the first user not via the corporate email ID of the first user but via an alternative communication medium including an SMS or an automated voice call on the first user's direct line/mobile phone, with the first user's contact details (including user's mobile phone number, direct line number) extracted by the processor from the repository. Further, in accordance with the present disclosure, the reminder generated in respect of an urgent and/or important email could be escalated to a second user, preferably a superior of the first user in terms of the corporate hierarchy—with the information identifying (such a) second user extracted by the processor from the repository.

In accordance with the present disclosure, when un-actioned email originally directed to the first user is regarded as important and/or urgent and further warranting an escalation to the second user, then the processor automatically transmits the un-actioned email to the second user (with the corporate email ID extracted by the processor from the repository), thereby escalating the important and/or urgent email to the second user.

However, preferably, the un-actioned urgent and/or important email is escalated to the second user only after the processor tracks the mail box and the email related activities of the first user on a continuous basis and subsequently identifies that the email which has been regarded as urgent and/or important has not been actioned upon by the first user. Preferably, emails which have been regarded as urgent and/or important (by the processor) but have not been read and/or answered by the first user for a predetermined period of time (for example, 12 Hours) are automatically transmitted (forward, preferably in its entirety) to the second user who is preferably superior to the first user in terms of the corporate hierarchy, for further action.

In an alternative implementation, the processor firstly generates a reminder directed to the first user reminding him about an urgent and/or important email remaining it his mailbox unread and/or unanswered, and simultaneously transmits the said reminder to the second user, so that the second user (who is preferably superior to the first user in terms of corporate hierarchy) is aware of the fact that the first user is yet to read and/or respond to one of his which has been automatically regarded (by the processor) as being urgent and/or important. Preferably, after generating a reminder corresponding to an urgent and/or important un-actioned email, and directing the said reminder to the first user either an SMS or an automated phone call, and simultaneously transmitting the same reminder to the second user preferably via an automated email, the processor tracks the mailbox of the first user for a predetermined period of time to determine whether the first user reacts to the said reminder and actions (preferably reads and responds) the urgent and/or important email. In the event that the processor determines—after tracking the first user's mailbox for a predetermined time period—that the first user has not responded to the reminder (previously sent via either an SMS or an automated voice call) the important and/or urgent un-actioned email along with any attachments is escalated (forwarded) by the processor to a mailbox associated with the second user, for further action.

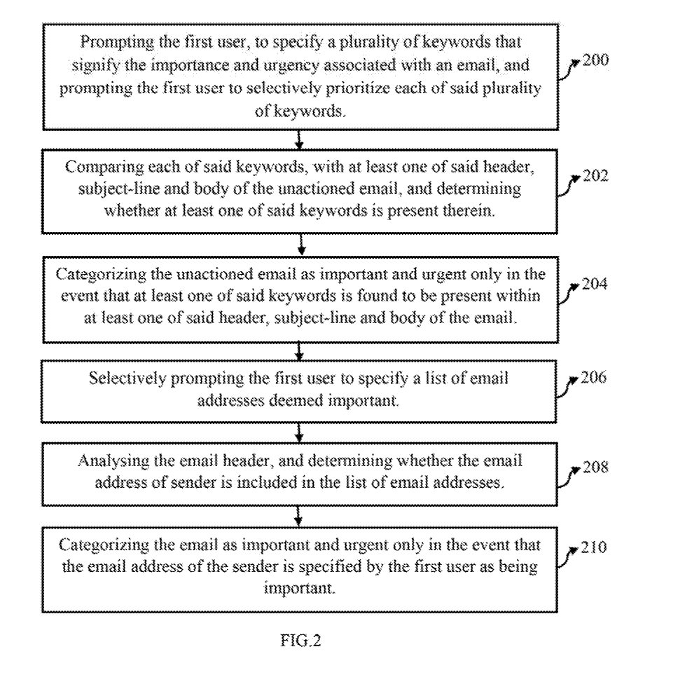

Referring to FIG. 2, there is shown a flow chart illustrating the steps corresponding to a second embodiment of the present disclosure, which teaches ascertaining an email addressed to the first user as being urgent and/or important depending upon the presence keywords which have been predefined by the first user as corresponding to important and/or urgent email communications. As shown in FIG. 2, at step 200, the processor prompts the first user via a computer enabled device (not shown in figures)—preferably the same computer enabled device used by the first user to access his mailbox—to specify at least a plurality of keywords, the presence of which in apt email, according to the first user, would render the said email to be deemed as important and/or urgent. Additionally, the processor prompts the first user to prioritize each of the keywords by the way of ranking each of them preferably in the increasing order of importance and urgency.

Subsequently, at step 202, soon after receiving a ranked list of keywords from the first user, the processor compares each of the entries (keywords) in the ranked list with the contents of each of the emails present in the mailbox of the first user. Preferably, the processor analyses the header, the subject-line and the body of each of the emails based on predetermined semantic analysis rules, and derives basis the semantic analysis, certain key-phrases indicative of the context of (each of) the emails. Subsequently, the processor compares each of the key-phrases with the ranked keywords specified by the user, and at step 204 categorizes an email as being urgent and/or important only in the event that the email is found to incorporate at least one key-phrase in either the header, the subject-line and the body thereof, semantically similar to any of the key-words specified by the first user.

Further, at step 206, the processor prompts the first user to specify a plurality of email IDs which according to him are associated with important people/senders whose emails are to be prioritized. Subsequently, at step 208 the processor analyses the headers of each of the emails (preferably, incoming emails), to determine if headers of any of the emails identify the sender as being an important person/important email sender, specified as such by the first user. Subsequently, at step 210 if an email header specifies the email ID of the sender as belonging to a person who has been specified as being important by the first user, then the processor categorizes the said mail as being important.

In accordance with the present disclosure, in the event that the none of the keywords specified by the first user match with the key-phrases extracted from the emails, and in the event that none of the people specified as important by the first user feature as senders in the emails, then the processor processes and selectively categorizes each of the emails as being urgent and/or urgent based on the process described in steps 100-120.

In accordance with an exemplary embodiment of the present disclosure, the computer processor, before analyzing the mailbox of the first user and identifying the un-actioned emails, interfaces with at least the calendar application—preferably a third-party calendar application that resides on first user's desktop computer/laptop computer/mobile phone/tablet and tracks the work schedule of the first user—to preferably determine first user's work schedule, at least for the present day. Subsequently, the processor learns from the calendar application that the first user is scheduled to attend an inter-departmental meeting from 9 AM to 10 AM, and that the first user is scheduled to attend yet another team meeting from 10 AM to 11 AM. Subsequently, the processor initiates analysis of all the emails being received on the mailbox of the first user, preferably, with an emphasis on emails received between 9 AM and 11 AM since the processor learns that the first user is most likely to be not checking his mailbox during the said time period.

Extending the aforementioned exemplary scenario, it is assumed that the first user receives ‘6’ emails between 9 AM and 11 AM, with the ‘first’ email having a subject-line ‘lunch today’ and being a query directed to availability for lunch at 12:30 PM the same day, and the ‘second’ email having a subject-line ‘first reminder-December invoice’ and being a first reminder towards a pending invoice remaining overdue for the last sixty days.

Further, the ‘third’ email having a subject-line ‘deadline for documents’ is an instruction requiring the first user to be emailing certain documents at the earliest, and the ‘forth’ email having a subject-line ‘give me a call’ is a request asking the first user to receive a family member from airport at 5 PM. Further, the ‘fifth’ email having a subject-line ‘Re: deadline for documents’ is a confirmation that the documents previously sent by the first user have been received, while the ‘sixth’ email with a subject-line ‘Re: first reminder-December invoice’ is a second reminder about an unpaid invoice which has remained as such since the last sixty days. The ‘sixth’ email also asks the first user for an immediate settlement of the pending invoice and speaks of a temporary suspension of the media account of the first user until the settlement of the pending invoice.

In accordance with the exemplary embodiment, the processor automatically analyses each of the ‘six’ emails in chronological order before deciding which out of the said ‘six’ emails are urgent and/or important. To begin with, the processor analyses the header of the ‘first’ email to identify the email ID of the sender (of the ‘first’ email), and further based on the said email ID and the predefined organizational hierarchy rules (which describe at least the designations of all the employees of the organization), identifies the sender to be a co-worker of the first user.

Subsequently, the processor analyses the subject-line of the ‘first’ email which reads ‘lunch today’, and the body of the first email which reads ‘Just touching base to see yon are still available lunch today?’, and determines that the body and the subject line of the ‘first’ email contain no words that convey a negative sentiment, and subsequently categorizes the ‘first’ email as conveying a positive sentiment. Further, the processor analyses the subject-line and the body of the ‘first’ email to identify key-phrases that identify an action, and consequentially identifies the key-phrases ‘lunch’, and ‘today’. Further, the processor identifies the key-phrase ‘12:10 PM’ as specifying a timeline, and further combines the key-phrases ‘lunch’, ‘today’, and ‘12:30 PM’ (basis pre-defined semantic analysis rules) to arrive at a conclusion that the ‘first’ email is directed to a request for a lunch to be scheduled the same day at 12:30 PM.

Further, the processor performs a temporal analysis of the ‘first’ email and determines—based at least in-part on all the previous communications between the sender of the ‘first’ email and the first user—that that the ‘first’ email is a routine query and is not pertinent to any of the work responsibilities of the first user. Subsequently, the processor, based on the key-phrase ‘12:30 PM’ and further based on the schedule of the first user received from the calendar application, determines that the requested lunch appointment is ‘1 Hour 30 Minutes’ away from when the first user completes his pre-designated meetings. Further, the processor discovers the current time of the day and calculates a time difference between the current time and the time at which the lunch requested.

Subsequently, the processor determines the ‘first’ email to be positive in sentiment (given the absence of any negative words in the body and subject-line thereof) and non-critical, routine in nature (given the absence of key-phrases signifying urgency factors and critical actions) and being received from a co-worker (based on pre-defined organizational hierarchy rules), and having a time factor (12:30 PM, same day). Since the processor determines the ‘first’ email to be conveying a positive sentiment, addressed by a co-worker and being non-critical in nature, the ‘first’ email is not categorised by the processor as either urgent or important.

However, the processor, considering the time factor (12:30 PM, same day) associated with the ‘first’ email, creates and transmits an ‘auto-reply’ email informing the sender of the ‘first’ email that the first user is away from the desk until 11 AM, and that he should expect a reply only thereafter. Further, the processor also updates the calendar application accessible to the first user by creating a ‘tentative’ calendar event tentatively confirming a lunch appointment at 12:30 PM the same day, and subsequently creates respective notifications (designated to be sent to the first user at 11:15 AM since the calendar application specifies the meeting to end at 11 AM) reminding the first user about the tentative lunch appointment as well as about the un-actioned ‘first’ email.

Further, the processor analyses the header of the ‘second’ email to identify the email ID of the sender (of the ‘second’ email), and further based on the said email ID and the predefined organizational hierarchy rules (which describe at least the designations of all the employees of the organization), identifies the sender to be a manager working for a third-party organization. Subsequently, the processor analyses the subject-line of the ‘second’ email which reads ‘first reminder-December invoice’, and the body of the ‘second’ email which reads ‘An urgent reminder that our invoice for media buys and placements purchased for December campaigns remains unpaid and is now 60 days overdue.’ The processor, based on the analysis of the subject-line identifies the key-phrases ‘reminder’, ‘December’ and “Invoice”. Further, the processor, based on the analysis of the (‘second’) email body identifies the key-phrases ‘urgent’, ‘reminder’, ‘unpaid’, ‘December’, ‘invoice’ and ‘overdue’. Further, based on the organizational hierarchy rules, the processor identifies the sender (of the second email) as a manager employed with a third-party vendor.

Further, based on the presence of key-phrases ‘urgent’ and ‘reminder’ in the subject-line and the presence of key-phrases ‘reminder’, ‘unpaid’, ‘invoice’ and ‘overdue’ in the body of the ‘second’ email, the processor determines the second email to be conveying a neutral sentiment. Further, the presence of key-phrase ‘urgent’ denotes an urgency factor with the ‘second’ email, while the terms ‘reminder’, ‘unpaid’ and ‘overdue’ denote the fact that the ‘second’ email should be brought to the immediate notice of the first user. Further, a temporal analysis of the email trail corresponding to the ‘second’ email reveals two more emails requesting settlement of the December invoice being directed to the first user by the sender (of the ‘second’ email).

Therefore, based on the presence of the aforementioned key-phrases and based on the identification of the sender (of the second email) as a manager, and based on the temporal analysis of the corresponding email trail, the processor categorizes the second email as being important as well as urgent, and preferably highlights the ‘second’ email—while it is being displayed in the mailbox of the first user—using a predetermined colour marker. Since the processor identifies the presence of key-phrases ‘invoice’ and ‘overdue’, the ‘second’ email is escalated (transmitted) on an immediate basis to at least one email ID associated with the ‘Accounts Department’ of the organization, with the email ID associated with accounts department identified by the processor using the organizational hierarchy rules. Further, since the ‘second’ email is regarded as both urgent and important, the processor creates a reminder notification to be displayed to the first user at 11:30 AM—i.e. half an hour after the first user completes his prescheduled meetings.

Subsequently, the processor analyses the subject-line of the ‘third’ email which reads ‘deadline for documents’ and the body of the ‘third’ email which reads ‘We haven't yet received the creative files for your ad placement. We really need to receive your print-ready file by 12 pm today in order to make the deadline for Thursday publication’. The processor, based on the analysis of the subject-line (of the ‘third’ email) identifies the key-phrases ‘documents’ and ‘deadline’. Further, the processor, based on the analysis of the (‘third’) email body identifies the key-phrases ‘deadline’, ‘12 PM’, ‘today’, ‘ad placement’ and ‘files’. Further, based on the organizational hierarchy rules, the processor identifies the sender (of the third email) as a media vendor with a third-party organization.

Further, based on the presence of key-phrases ‘documents’ and ‘deadline’ in the subject-line and based on the presence of key-phrases ‘deadline’, ‘12 PM’, ‘today’, ‘ad placement’ and ‘files’ in the body of the ‘third’ email, the processor determines, the ‘third’ email to be conveying a neutral sentiment. Further, the presence of key-phrases ‘deadline’, ‘12 PM’, ‘today’ denote an urgency factor with the ‘third’ email as well as an action required to be undertaken by the first user within a specific time frame, thereby indicating that the ‘third’ email should be brought to the immediate notice of the first user. Further, a temporal analysis of the email trail corresponding to the ‘third’ email reveals two more emails requesting art immediate release of the documents, being directed to the first user by the sender (of the ‘third’ email).

Therefore, based on the presence of the aforementioned key-phrases (corresponding to the subject-line and body of the ‘third’ email) and based on the identification of the sender (of the third email) as a media vendor, and based on the temporal analysis of the corresponding email trail, the processor categorizes the ‘third’ email as being important as well as urgent, and preferably highlights the ‘third’ email—while it is being displayed in the mailbox of the first user—using a predetermined colour marker. Since the processor identifies the presence of key-phrases ‘ad placement’ and ‘creative’, the ‘third’ email is automatically escalated (transmitted) on an immediate basis to at least one email ID associated with the ‘marketing department’ and ‘design department’ of the organization respectively. Preferably, the email IDs associated with marketing department and the design department are identified by the processor based on the organizational hierarchy rules. Further, the presence of keywords ‘12 PM’ and ‘today’ and ‘deadline’ in the email body cause the processor to categorize the ‘third’ email as urgent as well as important, and subsequently create and direct a reminder notification—pertaining to the ‘third’ email—to the first user on an immediate basis. Alternatively, the processor directs a reminder notification to the first user at 10 AM thereby interrupting the first user during his meeting and communicating to the first user the urgency associated with the ‘third’ email by the way of sending him said reminder notification on an immediate basis, and thereby prompting the first user to take necessary actions on an immediate basis as warranted by the ‘third’ email.

Subsequently, the processor analyses the subject-line of the ‘forth’ email which reads ‘give me a call’, and the body of the ‘forth’ email which reads ‘A meeting got dropped on me. Not happy about it but unfortunately, I won't be able to drop Robbie off at his soccer today. Call me back and let me know if you can get away early today or if we have to sort something else out’. The processor, based on the analysis of the subject-line (of the ‘forth’ email) identifies the key-phrases ‘call’ and ‘back’. Further, the processor, based on the analysis of the (‘forth’) email body identifies the key-phrases ‘Robbie’, ‘Soccer’, ‘early’ and ‘today’. Further, the processor analyses the header of the ‘forth’ email to identify the email ID of the sender (of the ‘forth’ email). The processor further performs a lookup for the email ID of the sender across the organizational hierarchy, and determines, in this case, that the email ID of the sender of the ‘forth’ email has not been specified across the organizational hierarchy. Accordingly, the processor categorizes the sender of the ‘forth’ email as a personal contact of the first user.

Further, based on the presence of key-phrases ‘call’ and ‘back’ in the subject-line and based on the presence of key-phrases ‘Robbie’, ‘Soccer’, ‘early’ and ‘today’ in the body of the ‘forth’ email, the processor determines the ‘forth’ email to be conveying a neutral sentiment. Further, the presence of key-phrase ‘today’ signifies an urgency factor with the ‘forth’ email as well as an action required to be undertaken by the first user within a specific time frame, thereby indicating that the ‘forth’ email should be brought to the immediate notice of the first user. Further, a temporal analysis of the email trail corresponding to the ‘forth’ email identifies the sender of the forth email as being a member of the family of the first user.

Further, the processor, based on the presence of keywords ‘Robbie’, ‘Soccer’ and ‘today’, and based on the identification of the sender (of the ‘forth’ email) as a family member, categorizes the email to be a personal message and as not being urgent and/or important as far as the work responsibilities of the first user are concerned. However, since the ‘forth’ email is determined to be originated from a family member, and since the ‘forth’ email incorporates the keywords ‘early’ and ‘today’, the processor creates a reminder notification deliverable to the first user at 12 PM reminding him about the ‘forth’ email from his family member,

Further, the processor analyses the subject-line of the ‘fifth’ email which reads ‘Re: deadline for documents’, and the body of the ‘fifth’ email which reads ‘Just received your documents pertaining to Thursday's ad—Thanks’. The processor, based on the analysis of the subject-line (of the ‘fifth’ email) identifies the key-phrases ‘Re:’, ‘deadline’ and ‘documents’. Based on the key-phrase ‘Re:’ the processor determines the ‘fifth’ email to be a replay to an earlier email sent by the first user, Further, the processor, based on the analysis of the (‘fifth’) email body identifies the key-phrases ‘received’, ‘documents’, ‘Thursday’ and ‘ad’. Further, the processor analyses the header of the ‘fifth’ email to identify the email ID of the sender (of the ‘fifth’ email). The processor further performs a lookup for the email ID of the sender across the organizational hierarchy and identifies the sender to be a media coordinator working for a third-party organization. Further, based on the presence of key-phrases ‘received’, ‘documents’, ‘Thursday’ and ‘ad’ in the body of the ‘fifth’ email, the processor determines the ‘fifth’ email to be conveying a positive sentiment.

Further, a temporal analysis of the email trail corresponding to the ‘fifth’ email reveals two more earlier emails on the email trail, with the first email of the email trail being an email directed to the first user requesting for the documents, and with the second email of the email trail being a response from the first user—the response also including the requested documents, as an attachment.

Further, the presence of key-phrases ‘received’, ‘documents’. ‘Thursday’ and ‘ad’ within the <body of the ‘fifth’ email triggers the processor to emphasize firstly on the key-phrase ‘Thursday’ and derive the current timestamp from the calendar application accessible to the first user, and further determine whether the current timestamp is earlier than ‘Thursday’. In the event that the current timestamp derived from the calendar application is earlier than Thursday, the processor regards the ‘fifth’ email as a confirmatory email which is neither urgent not important and accordingly decides not to escalate the ‘fifth’ email. In this case, since the confirmatory nature of the ‘fifth’ email triggers the processor not to regard the said email as either important or urgent or both, no reminders (directed to the first user) are created in respect of the fifth email.

Further, the processor analyses the header of the ‘sixth’ email to identify the email ID of the sender (of the ‘sixth’ email), and further based on the said email ID and the predefined organizational hierarchy rules (which describe at least the designations of all the employees of the organization), identifies the sender to be a senior manager working for a third-party organization.

Subsequently, the processor analyses the subject-line of the ‘sixth’ email which reads ‘second reminder-December invoice’, and the body of the ‘sixth’ email which reads ‘I would like to point out that our December invoice remains unpaid. A number of weeks ago you said that you would insure that the account was brought up to date—This has not happened and a number of follow up calls from me have gone unanswered. This matter needs to be addressed immediately and until such time your media account with us has been suspended and your placement scheduled for Thursday will not be published. Please contact me immediately in order to clear up this matter’.

The processor, based on the analysis of the subject-line (of the ‘sixth’ email) identifies the key-phrases ‘second’, ‘reminder’, ‘December’ and ‘Invoice’. Further, the processor, based on the analysis of the body of the ‘sixth’ email identifies the key-phrases ‘December’, ‘invoice’ ‘unpaid’, ‘not’. ‘unanswered’, ‘immediately’, ‘media account’. ‘suspended’.

Further, based on the presence of key-phrases ‘second’, ‘reminder’, ‘December’ and ‘invoice’ in the subject-line and the presence of key-phrases December’, ‘invoice’ ‘unpaid’, ‘not’, ‘unanswered’, ‘immediately’, ‘media account’, ‘suspended’ in the body of the ‘sixth’ email, the processor determines the ‘sixth’ email to be conveying a negative sentiment. Further, the occurrence of key-phrase ‘immediately’ twice across the body of the ‘sixth’ email denotes an urgency factor associated with the ‘sixth’ email, while the term ‘contact me’ signifies an action required to be undertaken by the first user in response to the ‘sixth’email. Further, a temporal analysis of the email trail corresponding to the ‘sixth’ email reveals three more earlier emails directed to the first user, with two out of the three earlier emails requesting settlement of the December invoice and the third email being a first reminder regarding the non-payment of the December invoice.

Therefore, based on the presence of the aforementioned key-phrases and based on the identification of the sender (of the sixth email) as a senior manager, and based on the temporal analysis of the corresponding email trail, the processor categorizes the ‘sixth’ email as being important as well as urgent, and preferably highlights the ‘sixth’ email—while it is being displayed in the mailbox of the first user—using a predetermined colour marker. Since the processor identifies the presence of key-phrases ‘immediately’ and ‘not’. ‘unpaid’, ‘suspended’ the ‘sixth’ email is escalated (transmitted) on an immediate basis to the email IDs associated with the ‘accounts Department’, ‘media management team’ of the organization, with the email IDs associated with the accounts department and the media management team identified by the processor using the organizational hierarchy rules. Further, since the ‘second’ email is regarded as both urgent and important, the processor creates a reminder notification to be displayed to the first user on an immediate basis, thereby interrupting the first user during his meeting and notifying, him by the way of the reminder notification, about the urgency associated with the ‘sixth’ email, and further prompting the first user to take necessary actions on an immediate basis as warranted by the ‘sixth’ email.

### TECHNICAL ADVANTAGES

The technical advantages envisaged by the present disclosure include the realization of a computer-implemented system and method that enable seamless integration of a plurality of client email services such as Webmail, Outlook, and MS exchange, in addition to enabling the email services to be seamlessly integrated with a variety of computer-based functions such as Calendar, To-Do Manager, Contact Lists and the like. Further, the system and method envisaged by the present disclosure processes the incoming mails (emails directed to a first user's mailbox) based on at least the syntax, semantics and context thereof, and automatically creates a tentative calendar event to alert the user about any of the impending events/meetings/conferences discussed in the incoming emails, in addition places an automated phone call/auto-reply email to the email sender to confirm a tentative—subject to a final approval from the user—participation of the user.

Further, the system and method envisage creating time-based notifications which are in-turn brought to the attention of the user either through au automated voice call or through an automated email, so as to ensure that the user is aware of his work-related responsibilities and personal responsibilities despite having left at least some of his emails un-actioned. In addition to functioning as an email analytical tool, the system and method is also rendered capable of functioning as a software-based tool that analyses any text-based document irrespective of its type and lists out the contents discussed/described in said text-based documents in addition to forecasting—in an artificially intelligent manner—the actions to be undertaken based on the contents of said text-based documents. Further, the system and method envisaged by the present disclosure are configured to analyse and summarize the key concepts/pointers specified in an email—with the functionality capable of being extended to textual documents of other format—while ignoring the portions deemed non-essential. Further, the system and method envisaged by the present disclosure is configured to be seamlessly integrated with a plurality of Operating Systems specific email interfaces including Android, IOS, Windows and the like.

The system and method, as envisaged by the present disclosure, are configured to implement a combination of analytical procedures including semantic analysis, sentiment analysis, pragmatic analysis, organizational hierarchy analysis, to analyse the emails directed to a (the) first user, and determine the characteristics of the emails, including (but not restricted to) their urgency, importance and confidentiality. Additionally. the system and method are also configured to track the origin (user profile of the sender) and the nature (work-related, personal) of the emails, and determine the email's importance/urgency based at least partly on the user profile of the email sender, and the email type (nature of the emails), thereby ensuring that the (first) user does not unintentionally neglect any of the urgent and/or important work related and that the (first) user receives, only the most important work related emails—with the importance of the emails highlighted preferably using a different font and colour—during his off-duty hours. Further, the system and method are configured to be used either to analyse incoming emails in real-time or to draw out an analysis of historical (email based) communications. In the event that the first user fails to respond, preferably within a predetermined time period, to an email communication deemed urgent and/or important, then the system/method automatically notifies a second user—who is preferably senior in terms of organizational hierarchy to the first user—about the said unanswered urgent and/or important email, in addition to preferably forwarding the said unanswered email to the second user (for further action), and also in addition to generating periodic reminders directed to the first user reminding him about the said unanswered urgent and/or important email.

Further, the system and method envisaged by the present disclosure are provided with an ability to identify and subsequently separate email communications that require urgent attention from standard/routine communications and create an automated acknowledgement as a response to such urgent email communications, in addition to bringing such an email to the notice of the user as well as his superiors by the way of timely reminders.

Further, the system and method envisaged by the present disclosure also ensure that every email, whether work-related or personal, is analysed in real-time and its urgency and/or importance is determined, also in real-time, so as to ensure that such urgent and/or important emails are highlighted on a continuous basis while being present on the mailbox of the first user, thereby enabling the (first) user to action such highlighted emails on a priority basis. Further, the system and method envisaged by the present disclosure ensure that emails communications having similarity in terms of recipients and contents are segregated and presented to the (first) user as a unified email chain/trail.

Further, the system and method envisaged by the present disclosure assists the (first) user in prioritizing urgent and/or important emails, by the way of displaying such urgent and/or important emails at the top most positions of the (incoming) email list, and ensuring, in the process that the user does not divert his attention to emails Which not as important and/or urgent. The system and method act as a virtual watch dog by constantly reminding the user, albeit non-intrusively by the way of user friendly methods of email highlighting, the presence of urgent and/or important un-actioned/unanswered emails in his mailbox. Highlighting of urgent and/or important un-actioned/unanswered emails ensures that the user never neglects an important and/or urgent email, while also ensuring that the incoming emails are prioritized in a customized manner based on user email interaction history, user behavioural data, and user's work profile inter-alia.

Further, the system and method envisaged by the present disclosure envisages generating a consolidated view incorporating all the emails received and sent by the first user over a predetermined period of time. In case of an organization implementing the system and method envisaged by the present disclosure, all the emails directed to and from each of the employees of the organization are consolidated and presented for display on a user interface, thereby enabling the Human Resource Management (HRM) personnel of the said organization to be able to view and subsequently analyze email related activities of each of the employees, and gain an insight into the organizational behaviour of each of the employees. Further, the system and method envisaged by the present disclosure also provides for each of the employees to be continually monitored and preferably ranked inter-alia based on the alacrity with which they respond to/action the incoming emails. Optionally, the system and method envisage populating the first user's mailbox with incoming emails, only if the first user is found to be ‘online’. Further, the system and method track the off-duty days of the first user by interfacing with the calendar application, and preferably populates the mailbox only in the event that the first user is determined to be on duty. Further, the system and method are rendered capable of filtering and optionally deleting auto-generated emails which are deemed unlikely to be read/actioned upon by the first user. By accessing the first user's history pertaining to the emails, the system and method provide for identifying and subsequently blocking emails, preferably only the auto-generated emails which are determined as being generated from provisioning servers whose earlier emails have never been read/actioned upon by the first user. Further, the system and method also provide for the emails (of the first user) to be associated with tags describing the email and the status thereof (for example, email read, email unread, email actioned, email un-actioned and the like). Preferably, the system and method provide for such tags to be embedded with the corresponding emails and render the tags viewable for other users, for example, the Human Resource Management (HRM) personnel employed with the organization the first user works for.

What is claimed is:

1. A computer-implemented method for reminding a first user about un-actioned emails in a mail box accessible to the first user, based on at least urgency and importance determined to be associated with the un-actioned emails, said method comprising the following computer-implemented steps:
accessing, using a computer processor, the mail box linked to the first user, and identifying at least one un-actioned email therefrom;
analysing, by the processor, at least one of a header, subject-line and body of the un-actioned email, and identifying therefrom, using predetermined sentiment analysis rules, key-phrases that signify at least one sentiment;
determining, by the processor, the importance associated with the un-actioned email by analysing at least said header of the un-actioned email using predefined organizational hierarchy rules;
analysing, by the processor, said subject-line and said body of the un-actioned email, and determining at least one of events, time stamps and actions specified therein, using predetermined semantic analysis rules;
identifying, by the processor using said semantic analysis rules, at least one urgency factor specified in the un-actioned email, and determining a time-sensitivity associated with the un-actioned email based on said at least one urgency factor;
analysing, by the processor, an email trail incorporating the un-actioned email and determining at least a temporal dimension corresponding to said email trail and a temporal progression of said email trail, and modelling the first user's behavioural profile based at least in-part on said temporal dimension and temporal progression;
pragmatically summarizing, by the processor, contents of the un-actioned email by assessing at least intentions conveyed by said subject-line and said body of the un-actioned email and purported impacts associated with conveyed intentions;
selectively categorizing, by the processor, the un-actioned email as being important and urgent, based at least one of said key-phrases, header of the un-actioned email, events, time stamps and actions described in the un-actioned email, urgency factor, temporal dimension and temporal progression of said email trail incorporating the un-actioned email, and said intentions conveyed by said contents of the un-actioned email and purported impacts associated with the conveyed intentions;
generating, by the processor, a reminder corresponding to the un-actioned email, subsequent to determining the urgency and importance associated with the un-actioned email, and directing said reminder to the first user thereby reminding the first user to respond to the un-actioned email, wherein said reminder is transmitted to the first user using a communication medium other than email communication; and
selectively directing said reminder to a second user in addition to the first user, based on the urgency and importance associated with the un-actioned email, said second user identified based on said organizational hierarchy rules and wherein said reminder is transmitted to said second user using a communication medium other than the email communication.

2. The method as claimed in claim 1, wherein the step of determining the importance associated with the un-actioned email by analysing at least a header of the un-actioned email, further includes the step of determining an identify of sender of the un-actioned email, and determining the un-actioned email to be important based on said identity of said sender.

3. The method as claimed in claim 1, wherein the step of determining the importance associated with the un-actioned email, further includes the step of analysing said subject line of the un-actioned email using said semantic analysis rules, and determining the un-actioned email to be important based on text specified as a part of said subject-line.

4. The method as claimed in claim 1, wherein the step of identifying key-phrases from the un-actioned email, further includes the step of associating each of the key-phrases with at least one of a positive sentiment, negative sentiment and neutral sentiment, and assigning weights to each of said key-phrases based on respective sentiments conveyed by each of the key-phrases, and combining said sentiments conveyed by each of the key-phrases using a machine-learning model to determine an overall sentiment associated with the un-actioned email.

5. The method as claimed in claim I, wherein the step of identifying at least one urgency factor specified in the un-actioned email, further includes the step of determining whether the un-actioned email specifies a deadline.

6. The method as claimed in claim 1, wherein the step of identifying at least one urgency factor specified in the un-actioned email, further includes the step of determining a timestamp at which the un-actioned email was sent, and determining whether the sender of the un-actioned email had previously sent a substantially similar email.

7. The method as claimed in claim 1, wherein the step of determining at least a temporal dimension corresponding to said email trail and a temporal progression of said email trail, further includes the step of determining a time gap between a first email and a last email of said email trail, number of emails exchange over a predefined period of time, time expired since the last email on said email trail, total number of emails on said email trail, and average time between creating a second email thread with said same sender.

8. The method as claimed in claim I, wherein the method further includes the following steps:
selectively prompting the first user, via an interne enabled device accessible to the first user, to specify a plurality of keywords that specify the importance and urgency associated with the un-actioned email, and further prompting the first user to selectively prioritize each of said plurality of keywords;
comparing each of said keywords, with at least one of said header, subject-line and body of the un-actioned email, and deter whether at least one of said keywords is present therein; and
categorizing the un-actioned email as important and urgent only in the event that at least one of said keywords is found to be present within at least one of said header, subject-line and body of un-actioned email.

9. The method as claimed in claim 8, wherein the method further includes the following steps:
selectively prompting the first user to specify a list of email addresses deemed important;
analysing at least said header of the un-actioned email, and determining whether email address of sender of un-actioned email is included in the list of email addresses specified by the first user as being important; and
categorizing the un-actioned email as important and urgent only in the event that the email address of the sender is specified by the first user as being important.

10. The method as claimed in claim 1, wherein the step of categorizing the un-actioned email as being important and urgent, further includes the step of automatically triggering a calendar event notification corresponding to at least one event described in the un-actioned email determined as being important and urgent, said calendar event notification directed to at least one of said first user and second user, via a communication medium other than the email communication, said communication medium selected from the group consisting of SMS and automated phone call.

11. A computer-implemented system for reminding a first user about un-actioned emails in a mail box accessible to the first user, based on at least urgency and importance determined to be associated with the un-actioned emails, said system comprising:
a memory module;
a processor operatively coupled to said memory module, said processor configured to:
access the mail box corresponding to the first user, and identify at least one un-actioned email therefrom;
analyse at least one of a header, subject line and body of the un-actioned email, and identify therefrom, using predetermined sentiment analysis rules, key-phrases that signify at least one sentiment;
determine the importance associated with the un-actioned email by analysing at least said header of the un-actioned email, using predefined organizational hierarchy rules;
identify at least events, time stamps and actions specified in the subject-line and body of the un-actioned email, using predetermined semantic analysis rules;
identify, based on said semantic analysis rules, at least one urgency factor specified in the un-actioned email, and determine a time-sensitivity associated with the un-actioned email based on said at least one urgency factor;
analyse an email trail incorporating the un-actioned email and determine at least a temporal dimension corresponding to said email trail and a temporal progression of said email trail, and model the first user's behavioural profile based at least in-part on said temporal dimension and temporal progression;
pragmatically summarize contents of the un-actioned email by assessing at least intentions conveyed by the subject-line and body of the un-actioned email and purported impacts associated with conveyed intentions;
selectively categorize the un-actioned email as being important and urgent, based at least one of said key-phrases, header of the un-actioned email, events, time stamps and actions described in the un-actioned email, urgency factor, temporal dimension and temporal progression of said email trail incorporating the un-actioned email, intentions conveyed by said contents of the un-actioned email and purported impacts associated with conveyed intentions;
generate a reminder corresponding to the un-actioned email, subsequent to determining the urgency and importance associated with the un-actioned email, and direct said reminder to the first user thereby reminding the first user to respond to the un-actioned email, wherein said reminder is transmitted to the first user using a communication medium other than email communication; and
selectively direct said reminder to a second user in addition to the first user, based on the urgency and importance associated with the un-actioned email, said second user identified based on said organizational hierarchy rules, wherein said reminder is transmitted to the second user using a communication medium other than email communication.

12. The system as claimed in claim 11, wherein said processor is further configured to determine the importance associated with the un-actioned email by analysing at least said header of the un-actioned email using predefined organizational hierarchy rules, said processor still further configured to determine an identify of sender of the un-actioned email, and further determine the un-actioned email to be important based on said identity of the sender.

13. The system as claimed in claim 11, wherein said processor is further configured to determine the importance associated with the un-actioned email by analysing said subject-line of the un-actioned email using said semantic analysis rules, said processor further configured to determine said un-actioned email to be important based on textual matter specified in said subject-line.

14. The system as claimed in claim 11, wherein said processor is further configured to associate each of said key-phrases with at least one of a positive sentiment, negative sentiment and neutral sentiment, said processor further configured to assign weights to each of said key-phrases based on said sentiment conveyed by each of the key-phrases, said processor still further configured to combine respective sentiments conveyed by each of the key-phrases using a machine-learning model to determine an overall sentiment associated with the un-actioned email.

15. The system as claimed in claim 11, wherein said processor is further configured to identify the at least one urgency factor specified in the un-actioned email, based on determining whether the un-actioned email specifies a deadline.

16. The system as claimed in claim 11, wherein said processor is further configured to identify the at least one urgency factor specified in the un-actioned email, based on determining a timestamp at which the un-actioned email was sent, and determining whether the sender of the un-actioned email had previously sent a substantially similar email.

17. The system as claimed in claim 11, wherein said processor is further configured to determine the temporal dimension corresponding to said email trail and temporal progression of said email trail, based on determining a time gap between a first email and a last email of the email trail, number of emails exchange over a predefined period of time, time expired since the last email on the email thread, total number of emails on the email thread, and average time between creating a second email thread with same sender.

18. The system as claimed in claim 11, wherein said processor is further configured to:
selectively prompt the first user, via an internet enabled device accessible to the first user and cooperating with said processor, to specify a plurality of keywords that specify the importance and urgency associated with the un-actioned email, and further prompt the first user to selectively prioritize each of said plurality of keywords;
compare each of said keywords, with at least one of said header, subject-line and body of the un-actioned email, and determine whether at least one of said keywords is present therein; and
categorize the un-actioned email as important and urgent, only in the event that at least one of said keywords is found to be present within at least one of said header, subject-line and body of un-actioned email.

19. The system as claimed in claim 18, wherein the processor is still further configured to:
selectively prompt the first user to specify a list of email addresses deemed important;
analyse at least said header of the un-actioned email, and determining whether email address of sender of un-actioned email is included in the list of email addresses specified by the first user as being important; and
categorize the un-actioned email as important and urgent only in the event that the email address of the sender is specified by the first user as being important.

20. The system as claimed in claim 11, wherein the processor is further configured to automatically trigger a calendar event notification corresponding to an event described in the un-actioned email determined as being important and urgent, said calendar event notification directed to at least one of said first user and second user, via a communication medium other than the email communication, said communication medium selected from the group consisting of SMS and automated phone call.

21. A non-transitory computer readable medium having computer readable instructions stored thereupon, the instructions when executed by a computer processor, cause the computer processor to:
access a mail box corresponding to a first user, and identify at least one un-actioned email therefrom;
analyse at least one of a header, subject line and body of the un-actioned email, and identify therefrom, using predetermined sentiment analysis rules, key-phrases that signify at least one sentiment;
determine the importance associated with the un-actioned email by analysing at least the header of the un-actioned email using predefined organizational hierarchy rules;
identify at least events, time stamps and actions specified in said subject-line and body of the un-actioned email, using predetermined semantic analysis rules;
identify, based on said semantic analysis rules, at least one urgency factor specified in the un-actioned email, and determine a time-sensitivity associated with the un-actioned email based on said at least one urgency factor;
analyse an email trail incorporating the un-actioned email and determine at least a temporal dimension corresponding to said email trail and a temporal progression of said email trail, and model the first user's behavioural profile based at least in-part on said temporal dimension and temporal progression;
pragmatically summarize contents of the un-actioned email by assessing at least intentions conveyed by the subject-line and body of the un-actioned email and purported impacts associated with conveyed intentions;
selectively categorize the un-actioned email as being important and urgent, based at least one of said key-phrases, header of the un-actioned email, events, time stamps and actions described in the un-actioned email, urgency factor, temporal dimension and temporal progression of said email trail incorporating the un-actioned email, intentions conveyed by said contents of the un-actioned email and purported impacts associated with conveyed intentions;
generate a reminder corresponding to the un-actioned email, subsequent to determining the urgency and importance associated with the un-actioned email, and direct said reminder to the first user thereby reminding the first user to respond to the un-actioned email;
transmit said reminder to the first user using a communication medium other than email communication;
selectively direct said reminder to a second user in addition to the first user, based on the urgency and importance associated with the un-actioned email, said second user identified using said organizational hierarchy rules; and
wherein said reminder is transmitted to the second user using a communication medium other than the email communication.

22, The non-transitory computer readable medium as claimed in claim 21, wherein the instructions when executed by the computer processor, further cause the computer processor to:
determine an identify of sender of the un-actioned email by analysing said header of the un-actioned email, and still further determine the un-actioned email to be important based on said identity of the sender of the email;
determine the un-actioned email to be important based on textual matter specified in the subject-line;
associate each of said key-phrases with at least one a positive positive sentiment, negative sentiment and neutral sentiment, and assign weights to each of the key-phrases based on the sentiment conveyed by each of the key-phrases, and combine the sentiments conveyed by each of the key-phrases using a machine-learning model to determine the sentiment associated with the un-actioned email;
identify the at least one urgency factor specified in the un-actioned email, based on determining whether the un-actioned email specifies a deadline;
identify the at least one urgency factor specified in the un-actioned email, selectively based on determining a timestamp at which the un-actioned email was sent, and based on determining whether the sender had previously sent a substantially similar email to the first user;
determine the temporal dimension corresponding to said email trail and temporal progression of said email trail, based on determining a time tap between a first email and a last email of the email trail, number of emails exchange over a predefined period of time, time expired since the last email on the email trail, total number of emails on the email trail, and average time between creating a second email thread with same sender;
selectively prompt the first user, via an internet enabled device accessible to the first user, to specify a plurality of keywords that specify the importance and urgency associated with the un-actioned email, and further prompt the first user to selectively prioritize each of said plurality of keywords;
compare each of said keywords, with at least one of said header, subject-line and body of the un-actioned email, and determine whether at least one of the keywords specified by the first user is present within at least one of said header, subject-line and body;
categorize the un-actioned email as important and urgent only in the event that at least one of the keywords is found to be present within at least one of said body, subject-line and body of the un-actioned;
selectively prompt the first user to specify a list of email addresses deemed important;
analyse at least said header of the un-actioned email, and determine whether an email address of the sender of the un-actioned email is incorporated in the list of email addresses specified by the first user as being important;
categorize the un-actioned email as important and urgent only in the event that the email address of the sender is specified by the first user as being important; and
automatically trigger a calendar event notification corresponding to an event described in the un-actioned email determined as being important and urgent, said calendar event notification directed to at least one of said first user and second user, via a communication medium other than the email communication, said communication medium selected from the group consisting of SMS and automated phone call.
